(19) United States
(12) Patent Application Publication
(10) Pub. No.: US 2026/0274041 A1
(43) Pub. Date: Sep. 17, 2026

(54) AIR CONDITIONER FOR VEHICLE AND CONTROL METHOD THEREOF

(71) Applicant: HANON SYSTEMS, Daejeon (KR)

(72) Inventors: Tae Wan KIM, Daejeon (KR); Yong Eun SEO, Daejeon (KR); Yeo Myeong YUN, Daejeon (KR); Tea Gun LEE, Daejeon (KR)

(21) Appl. No.: 19/472,019

(22) PCT Filed: May 23, 2024
(86) PCT No.: PCT/KR2024/006949

§ 371 Date: Oct. 2, 2025

(30) Foreign Application Priority Data
May 31, 2023 (KR) 10-2023-0070569
May 31, 2023 (KR) 10-2023-0070570

(51) Int. Cl. B60H 1/24; B60H 1/00

(52) U.S. Cl. CPC B60H 1/244; B60H 1/00664; B60H 2001/002; B60H 2001/00707

(57) ABSTRACT

An embodiment relates to an air conditioner for a vehicle, the air conditioner comprising: an air conditioning unit for controlling the temperature of air; and a rear seat distribution unit communicating with the air conditioning unit to guide the air of the air conditioning unit to a rear seat. The rear seat distribution unit includes: a housing communicating with the air conditioning unit and including a rear seat outlet; a rear seat blower disposed inside the housing; a main air volume adjustment door unit disposed in front of the rear seat blower; and an auxiliary air volume adjustment door unit disposed at the rear of the blower.

### TECHNICAL FIELD

The present invention relates to an air conditioning device for a vehicle that secures independent air amount controllability in multiple areas of a vehicle.

### BACKGROUND ART

Vehicles are provided with an air conditioner for controlling interior air temperature and ventilation. In addition, the air conditioner for a vehicle keeps a vehicle interior warm by generating warm air in the winter and keeps the vehicle interior cool by generating cold air in the summer. Here, the air conditioner for a vehicle can include an air conditioning unit for controlling the temperature of air through heat exchange between the air and a heat exchange medium, a blower for supplying air to the air conditioning unit, and a distribution unit for distributing the air discharged from the air conditioning unit to a specific position inside a vehicle.

The distribution unit can include a blower and a plurality of flow paths for independent air conditioning and individual control inside the vehicle. Accordingly, the air conditioner for a vehicle can implement individual air conditioning for front seats or rear seats inside the vehicle.

A portion of air of which temperature has been adjusted through the air conditioning unit can be provided to the rear seats. In this case, when a set value of the amount of air discharged to the front seats and a set value of an air volume discharged to the rear seats are different, the amount of air provided to the rear seats can be adjusted through a door disposed on the flow path of the distribution unit.

However, when a set value of the amount of air discharged to a left rear seat and a set value of the amount of air discharged to a right rear seat are different, there is a problem that it is difficult to control the amount of air discharged to the left rear seat and the right rear seat only with the door disposed on the flow path of the distribution unit. In order to increase the controllability of the air discharged to the left rear seat and the right rear seat, there is a proposal to add a return flow path toward the blower of the distribution unit, but this has the problem that noise is generated significantly due to a backflow of air.

### DETAILED DESCRIPTION OF INVENTION

### Technical Problem

In order to solve such a problem, the present invention is directed to providing an air conditioner for a vehicle and a control method thereof, which allow the controllability of the amount of air discharged to rear seats to be increased and noise to be reduced and allow sufficient air to be supplied from front seats to the rear seats during a process of adjusting the amount of air to left and rights of front seats.

Objects of the present invention are not limited to the above object, and other objects that are not described will be able to be clearly understood by those skilled in the art based on the following description.

### Technical Solution

According to an embodiment, there is provided an air conditioner for a vehicle, which includes an air conditioning unit configured to adjust a temperature of air, and a rear seat distribution unit configured to communicate with the air conditioning unit and guide air of the air conditioning unit to rear seats, wherein the rear seat distribution unit includes a housing that communicates with the air conditioning unit and includes a rear seat outlet, a rear seat blower disposed inside the housing, a main air amount adjustment door unit disposed in front of the rear seat blower, and an auxiliary air amount adjustment door unit disposed behind the blower, when there is a difference between a set value of the amount of air discharged to front seats and a set value of the amount of air discharged to the rear seats, the rear seat distribution unit adjusts an opening degree of the main air amount adjustment door unit to adjust the amount of air discharged through the rear seat outlet, and when there is a difference between a set value of the amount of air discharged to a left rear seat and a set value of the amount of air discharged to a right rear seat, an opening degree of the auxiliary air amount adjustment door unit is adjusted to adjust the amount of air discharged through the rear seat outlet.

A rotational shaft of the main air amount adjustment door unit and a rotational shaft of the auxiliary air amount adjustment door unit may be different with respect to a height direction of the rear seat outlet.

The rotational shaft of the main air amount adjustment door unit may be located on an inner wall of the rear seat outlet.

A first rotational shaft of the main air amount adjustment door unit may be disposed to be spaced apart from an inner wall of the rear seat outlet.

A first rotational shaft of the main air amount adjustment door unit may be disposed on an end of a main door, and a rotational shaft of the auxiliary air amount adjustment door unit may be disposed on a central portion of an auxiliary door.

The auxiliary door may include a sealer disposed on an end of the auxiliary door, and the sealer may come into contact with an inner wall of the rear seat outlet earlier than the auxiliary door.

The opening degree of the main door and the opening degree of the auxiliary door may be different.

The air conditioning unit may be formed to be divided into a front seat left flow path and a rear seat right flow path by a partition wall, and the distribution unit may be formed to be divided into a rear seat left flow path and a rear seat right flow path by a partition wall, and the rear seat outlet may communicate with the front seat left flow path and the rear seat left flow path, and the rear seat right flow path and the rear seat right flow path may communicate with each other.

The rear seat blower may include a left blower disposed on the rear seat left flow path and a right blower disposed on the rear seat right flow path, and the left blower and the right blower may be connected to one motor.

The auxiliary air amount adjustment door unit may include a left auxiliary air amount adjustment door unit disposed on the rear seat left flow path and a right auxiliary air amount adjustment door unit disposed on the rear seat right flow path.

When a set value of the amount of air discharged to the rear seat right flow path is greater than a set value of the amount of air discharged to the rear seat left flow path, an opening degree of the left auxiliary air amount adjustment door unit may be adjusted to be smaller than an opening degree of the right auxiliary air amount adjustment door unit.

When the set value of the amount of air discharged to the rear seat right flow path is smaller than the set value of the amount of air discharged to the rear seat left flow path, the opening degree of the left auxiliary air amount adjustment door unit may be adjusted to be greater than the opening degree of the right auxiliary air amount adjustment door unit.

The rear seat distribution unit may further include a mode door unit that is disposed behind the auxiliary air amount adjustment door unit and adjusts air discharged through a rear seat floor vent or a rear seat console vent.

According to an embodiment, there is provided an air conditioner for a vehicle, which includes: an air conditioning unit configured to adjust a temperature of air, the air conditioning unit including a main blower, a cooling heat exchanger, a heating heat exchanger, and a front seat distribution unit configured to guide air of the air conditioning unit to front seats; and a rear seat distribution unit that communicates with the air conditioning unit and guides air of the air conditioning unit to rear seats, the front seat distribution unit includes a front seat left and right air amount adjustment door for front seat left and right independent air amounts, the rear seat distribution unit includes a housing that communicates with the air conditioning unit and includes a rear seat outlet, a rear seat blower disposed inside the housing, and a rear seat air amount adjustment door for rear seat left and right independent air amounts, and a controller configured to control the rear seat air amount adjustment door according to a difference between the amounts of air of a left and a right of a front seat.

In an embodiment, the rear seat air amount adjustment door may include a main air amount adjustment door unit disposed in front of the rear seat blower, and an auxiliary air amount adjustment door unit disposed behind the rear seat blower, and in a state in which there is a difference between a first set value of the amount of air discharged to a left side of the front seat and a second set value of the amount of air discharged to a right side of the front seat, when a third set value of the amount of air discharged to a left side of a rear seat and a fourth set value of the amount of air discharged to a right side of the rear seat are the same, the rear seat distribution unit may reduce an opening degree of the auxiliary air amount adjustment door unit corresponding to the right side of the rear seat when the first set value is smaller than the second set value, and reduce the opening degree of the auxiliary air amount adjustment door unit corresponding to the left side of the rear seat when the second set value is smaller than the first set value.

In a state in which the first set value and the second set value are different, when the third set value and the fourth set value are the same, the rear seat distribution unit may increase a speed of the rear seat blower.

The opening degree of the auxiliary air amount adjustment door unit may be adjusted so that the amount of air discharged to the left side of the rear seat and the amount of air discharged to the right side of the rear seat are the same.

The rear seat distribution unit may change the speed of the rear seat blower in response to a speed of the front seat blower.

The air conditioning unit may be formed to be divided into a front seat left flow path and a rear seat right flow path by a partition wall, and the rear seat distribution unit is formed to be divided into a rear seat left flow path and a rear seat right flow path by a partition wall, and the rear seat outlet may communicate with the front seat left flow path and the rear seat left flow path, and the rear seat right flow path and the rear seat right flow path may communicate with each other.

The rear seat blower may include a left blower disposed on the rear seat left flow path and a right blower disposed on the rear seat right flow path, and the left blower and the right blower may be connected to one motor.

The auxiliary air amount adjustment door unit may include a left auxiliary air amount adjustment door unit disposed on the rear seat left flow path and a right auxiliary air amount adjustment door unit disposed on the rear seat left flow path.

According to an embodiment, there is provided a control method of the air conditioner for a vehicle, which includes an operation (a) of determining whether the first set value and the second set value are different, an operation (b) of determining whether the third set value and the fourth set value are the same when the first set value and the second set value are different, an operation (c) of increasing a rotation speed of the rear seat blower when the third set value and the fourth set value are the same, an operation (d) of reducing the opening degree of the auxiliary air amount adjustment door unit corresponding to the right side of the rear seat when the first set value is smaller than the second set value, and an operation (e) of reducing the opening degree of the auxiliary air amount adjustment door unit corresponding to the left side of the rear seat when the second set value is smaller than the first set value.

The opening degree of the auxiliary air amount adjustment door unit may be adjusted so that the amount of air discharged to the left side of the rear seat and the amount of air discharged to the right side of the rear seat are the same.

### Advantageous Effects

According to embodiments, it is possible to increase the controllability of the amount of air discharged to rear seats through an auxiliary door unit.

According to the embodiments, since there is no need to control the amount of air by returning air to a rear seat blower, it is possible to significantly reduce noise.

According to the embodiments, during a process of adjusting the amount of air to left and rights of front seats, sufficient air can be supplied from the front seats to the rear seats.

According to the embodiments, even when a set value of the amount of air required for the rear seats is greater than a set value of the amount of air required for the front seats, it is possible to improve a deviation of the amount of air of the rear seat and the amount of air of a right rear seat.

### DESCRIPTION OF DRAWINGS

FIG. 1 is a view showing an air conditioner for a vehicle according to an embodiment.

FIG. 2 is a view showing four zones of a vehicle.

FIG. 3 is a view showing a rear seat blower, a main air amount adjustment door unit, and an auxiliary air amount adjustment door unit of a distribution unit.

FIG. 4 is a view showing the main air amount adjustment door unit and the auxiliary air amount adjustment door unit.

FIG. 5 is a view showing a case in which the amounts of air flowing to rear seats facing a driver's seat and a front passenger's seat are the same in the case of four zones.

FIG. 6 is a view showing movements of a main air amount adjustment door unit and an auxiliary air amount adjustment door unit in the case of four zones of FIG. 5.

FIG. 7 is a view showing a case in which the amount of air discharged to rear seats is greater than the amount of air discharged to front seats in a state in which the amounts of air flowing to the driver's seat and the front passenger's seat are the same in the case of four zones.

FIG. 8 is a view showing movements of a main air amount adjustment door unit and an auxiliary air amount adjustment door unit in the case of four zones of FIG. 7.

FIG. 9 is a view showing the auxiliary air amount adjustment door unit.

FIG. 10 is a view showing a case in which the amounts of air flowing to the driver's seat and the front passenger's seat in the rear seats are different in the four zones.

FIG. 11 is a view showing movements of the main air amount adjustment door unit and the auxiliary air amount adjustment door unit in the case of four zones of FIG. 10.

FIG. 12 is a view showing a state in which the amounts of air of a left side of the front seat and a right side of the front seat are independently controlled in the four zones.

FIG. 13 is a view showing a control method of an air conditioner for a vehicle according to an embodiment.

### MODES OF THE INVENTION

Hereinafter, exemplary embodiments of the present invention will be described in detail with reference to the accompanying drawings.

However, the technical spirit of the present invention is not limited to some of the described embodiments, but may be implemented in various different forms, and one or more of the components among the embodiments may be used by being selectively coupled or substituted without departing from the scope of the technical spirit of the present invention.

In addition, terms (including technical and scientific terms) used in embodiments of the present invention may be construed as meaning that may be generally understood by those skilled in the art to which the present invention pertains unless explicitly specifically defined and described, and the meanings of the commonly used terms, such as terms defined in a dictionary, may be construed in consideration of contextual meanings of related technologies.

In addition, the terms used in the embodiments of the present invention are for describing the embodiments and are not intended to limit the present invention.

In the present specification, a singular form may include a plural form unless otherwise specified in the phrase, and when described as “at least one (or one or more) of A, B, and C,” one or more of all possible combinations of A, B, and C may be included.

In addition, terms such as first, second, A, B, (a), (b), and the like may be used to describe components of the embodiments of the present invention.

These terms are only for the purpose of distinguishing one component from another component, and the nature, sequence, order, and the like of the corresponding components is not limited by these terms.

In addition, when a certain component is described as being “connected,” “coupled,” or “joined” to another component, it may include a case in which the certain component is directly connected, coupled, or joined to another component, but also a case in which the certain component is “connected,” “coupled,” or “joined” to another component by still another component present between the certain component and another component.

In addition, when the certain component is described as being formed or disposed “on (above) or below (under)” another component, “on (above)” or “below (under)” may include not only a case in which two components are in direct contact with each other, but also a case in which one or more other components are formed or disposed between the two components. In addition, when described as “on (above) or below (under),” it may include the meaning of not only an upward direction but also a downward direction based on one component.

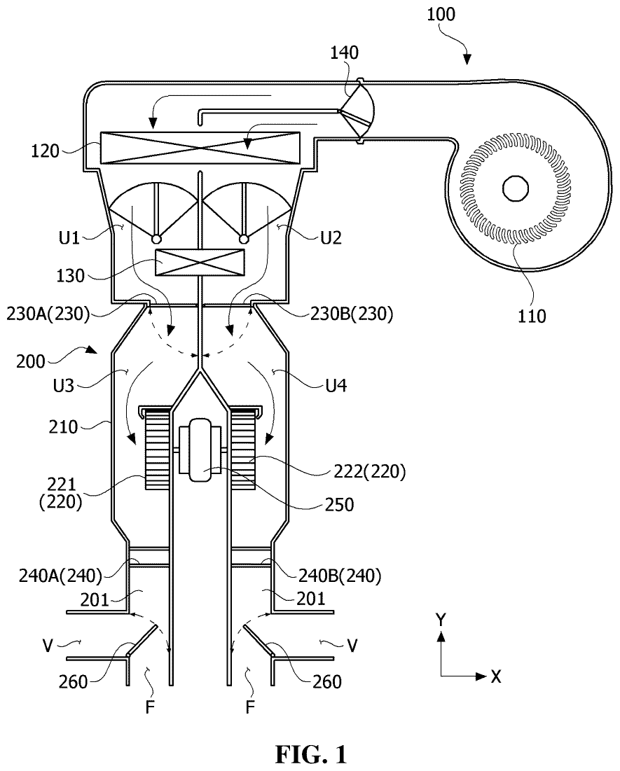

FIG. 1 is a view showing an air conditioner for a vehicle according to an embodiment. Hereinafter, in the drawings, an x-axis extends in a width direction of a vehicle, and a y-axis extends in a front-rear direction of the vehicle. A z-axis extends in a height direction of the vehicle. Hereinafter, a left may be a driver's seat side in the width direction of the vehicle, and a right may be a front passenger's seat side in the width direction of the vehicle.

Referring to FIG. 1, an air conditioner for a vehicle according to an embodiment may include an air conditioning unit 100 and a rear seat distribution unit 200.

The air conditioning unit 100 controls the temperature of air. The air conditioning unit 100 may adjust the temperature of air supplied through an air conditioning blower 110 and supply the air into the vehicle.

The air conditioning unit 100 may include a cooling heat exchanger 120, a heating heat exchanger 130, and a front seat distribution unit 140. Air that has passed through the cooling heat exchanger 120 is cooled, and air that has passed through the heating heat exchanger 130 is heated. The front seat distribution unit guides the air of the air conditioning unit 100 to front seats. The front seat distribution unit 140 may include front seat left and right air amount adjustment doors for independently adjusting the amounts of air to the left and right side of the front seats.

The air conditioning unit 100 may be formed to be divided into a front seat left flow path U1 and a front seat right flow path U2 by a partition wall.

The rear seat distribution unit 200 serves to communicate with the air conditioning unit 100 to guide air to rear seats.

The rear seat distribution unit 200 may include a housing 210, a rear seat blower 220, a main air amount adjustment door unit 230, and an auxiliary air amount adjustment door unit 240.

The housing 210 communicates with the air conditioning unit 100 and includes a rear seat outlet 201. The housing 210 may include a rear seat left flow path U3 and a rear seat right flow path U4. The rear seat left flow path U3 communicates with the front seat left flow path U1. The rear seat right flow path U4 communicates with the front seat right flow path U2.

The rear seat left flow path U3 guides air delivered from the front seat left flow path U1 to the rear seat outlet 201.

The rear seat right flow path U4 guides air delivered from the front seat right flow path U2 to the rear seat outlet 201.

The rear seat blower 220 includes a left blower 221 and a right blower 222. The left blower 221 is disposed on the rear seat left flow path U3. The right blower 222 is disposed on the rear seat right flow path U4. The left blower 221 and the right blower 222 are connected to one motor. Accordingly, rotation speeds of the left blower 221 and the right blower 222 are the same.

The main air amount adjustment door unit 230 is disposed in front of the rear seat blower 220. The main air amount adjustment door unit 230 may be disposed on each of the rear seat left flow path U3 and the rear seat right flow path U4. The auxiliary air amount adjustment door unit 240 is disposed behind the rear seat blower 220.

The main air amount adjustment door unit 230 is disposed between the front seat left flow path U1 and the rear seat left flow path U3 or between the front seat right flow path U2 and the rear seat right flow path U4 to adjust the amount of air flowing from the air conditioning unit 100 to the housing 210.

Looking at the overall flow of air, air is introduced into the air conditioning unit 100 by the rear seat blower 220. The air introduced into the air conditioning unit 100 is temperature-adjusted and supplied to the interior in which the front seats of the vehicle are located. Air is supplied to left space of the front seat of the vehicle through the front seat left flow path U1. Air is supplied to right space of the front seat of the vehicle through the front seat right flow path U2.

Some air of the air conditioning unit 100 is guided to the rear seat outlet 201 through the rear seat distribution unit 200. Air is supplied to left space of the rear seat of the vehicle through the rear seat left flow path U3. Air is supplied to right space of the rear seat of the vehicle through the rear seat right flow path U4.

Air discharged from the rear seat outlet 201 may be supplied to a rear seat console vent V or a rear seat floor vent F. A mode door unit 260 is disposed behind the rear seat outlet 201. The rear seat console vent V discharges air toward the face of a rear seat passenger. The rear seat floor vent F discharges air toward the feet of the rear seat passenger.

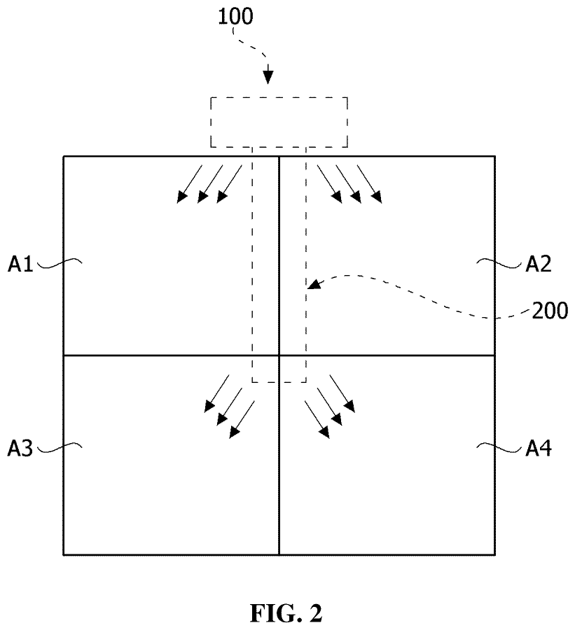

FIG. 2 is a view showing four zones of a vehicle.

Referring to FIGS. 1 and 2, an interior of the vehicle may be largely divided into four zones, which are a first zone A1, a second zone A2, a third zone A3, and a fourth zone A4. The first zone A1 and the second zone A2 correspond to the front seats of the vehicle, and the third zone A3 and the fourth zone A4 correspond to the rear seats of the vehicle.

The first zone A1 and the third zone A3 correspond to the driver's seat side of the vehicle, and the second zone A2 and the fourth zone A4 correspond to the front passenger's seat side of the vehicle.

Air temperature-controlled in the air conditioning unit 100 is supplied to the first zone A1 and the second zone A2, and a portion of the air temperature-controlled in the air conditioning unit 100 is supplied to the third zone A3 and the fourth zone A4 through the rear seat distribution unit 200.

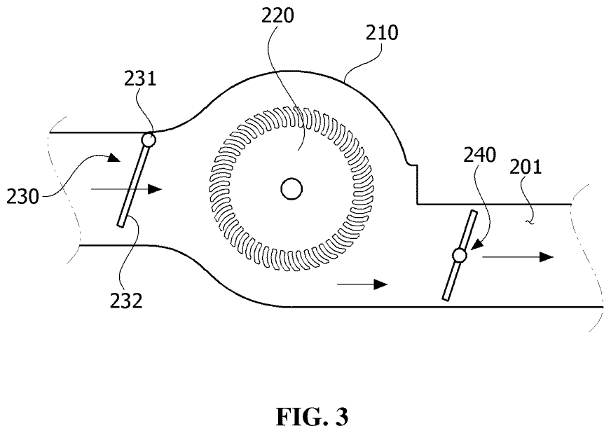

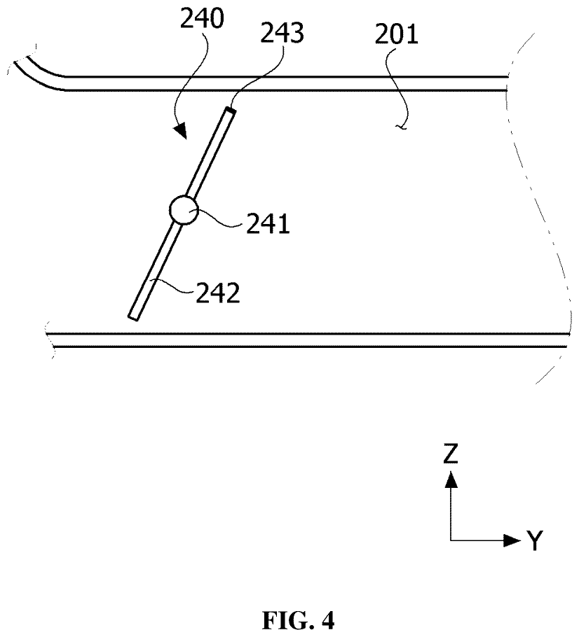

FIG. 3 is a view showing the rear seat blower 220, the main air amount adjustment door unit 230, and the auxiliary air amount adjustment door unit 240 of the rear seat distribution unit 200, and FIG. 4 is a view showing the main air amount adjustment door unit 230 and the auxiliary air amount adjustment door unit 240.

Referring to FIGS. 3 and 4, the main air amount adjustment door unit 230 is disposed in front of the rear seat blower 220, and the auxiliary air amount adjustment door unit 240 is disposed behind the blower 110. Air that has passed through the main air amount adjustment door unit 230 flows toward the auxiliary air amount adjustment door unit 240 by the rotation of the rear seat blower 220.

When there is a difference between a set value of the amount of air discharged to the front seats and a set value of the amount of air discharged to the rear seats, the main air amount adjustment door unit 230 serves to adjust the amount of air discharged through the rear seat outlet 201 by adjusting an opening degree.

When there is a difference between a set value of the amount of air discharged to a left rear seat and a set value of the amount of air discharged to a right rear seat in a state in which there is a difference between the set value of the amount of air discharged to the front seats and the set value of the amount of air discharged to the rear seats, the auxiliary air amount adjustment door unit 240 serves to independently adjust an opening degree of the rear seat left flow path U3 and an opening degree of the rear seat right flow path U4.

The main air amount adjustment door unit 230 may include a first rotational shaft 231 and a main door 232. The auxiliary air amount adjustment door unit 240 may include a second rotational shaft 241 and an auxiliary door 242. Locations of the first rotational shaft 231 and the second rotational shaft 241 may be different with respect to a height direction of the vehicle, that is, a height direction of the rear seat outlet 201. For example, the first rotational shaft 231 may be located on an inner wall of the rear seat outlet 201. The first rotational shaft 231 may be disposed on an end of the main door 232. The second rotational shaft 241 may be disposed to be spaced apart from the inner wall of the rear seat outlet 201. The second rotational shaft 241 may be disposed on a central portion of the auxiliary door 242.

In the case of the main air amount adjustment door unit 230, since a length from the first rotational shaft 231 to the end of the main door 232 is relatively long, the rotational displacement of an end of the auxiliary door 242 corresponding to the rotation of a motor 250 is great, and thus adjusting the amount of air is possible when there is a difference between the amount of air of the front seats and the amount of air of the rear seats.

In the case of the auxiliary air amount adjustment door unit 240, since the second rotational shaft 241 is disposed on the central portion of the auxiliary door 242, a length from the second rotational shaft 241 to the end of the auxiliary door 242 is short. Accordingly, since the rotational displacement of the end of the auxiliary door 242 corresponding to the rotation of the motor 250 is small, the amount of air can be adjusted more precisely than the main air amount adjustment door unit 230.

The auxiliary door 242 may include a sealer 243. The sealer 243 may be disposed on one end of the auxiliary door 242. The sealer 243 is in contact with the inner wall of the rear seat outlet 201 before the auxiliary door 242. Since the sealer 243 is in contact with the inner wall of the rear seat outlet 201 before the other side of the auxiliary door 242, the controllability of the amount of air can be further improved.

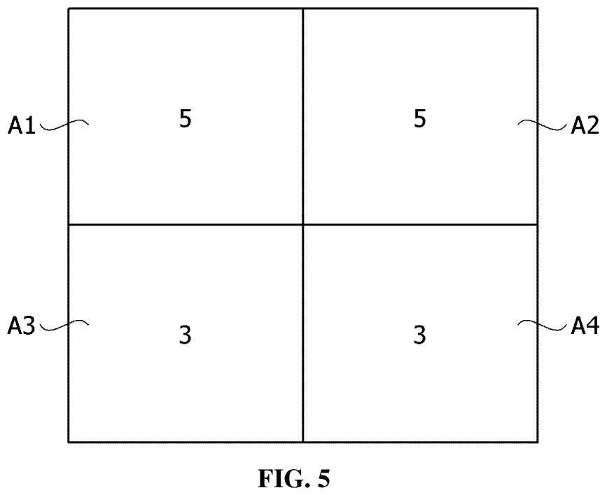

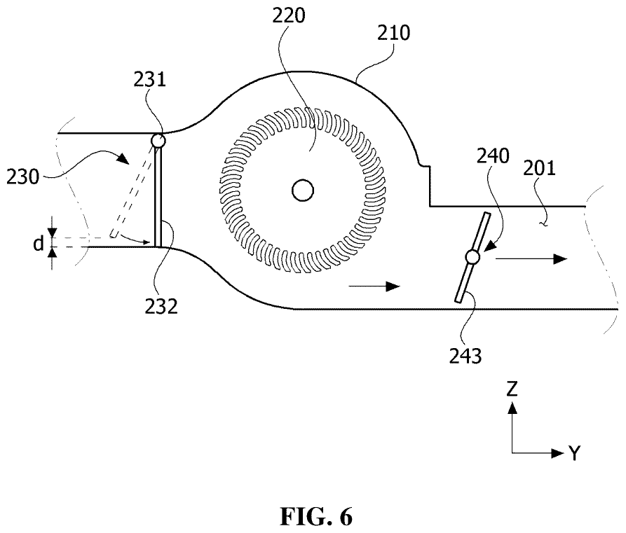

FIG. 5 is a view showing a case in which the amounts of air flowing to rear seats facing a driver's seat and a front passenger's seat are the same in the case of four zones, and FIG. 6 is a view showing movements of the main air amount adjustment door unit 230 and the auxiliary air amount adjustment door unit 240 in the case of four zones of FIG. 5.

Referring to FIGS. 5 and 6, when a set value of the amount of air discharged to the left side of the rear seat and a set value of the amount of air discharged to the right side of the rear seat are the same in a state in which the set value of the amount of air discharged to the front seats and the set value of the amount of air discharged to the rear seats are different, the amount of air discharged to the rear seats may be adjusted by adjusting the opening degree using only the main air amount adjustment door unit 230 without operating the auxiliary air amount adjustment door unit 240.

The set value of the amount of discharged air may be divided into a plurality of stages and changed according to a user's settings. For example, the set value of the amount of air is different for each stage, and the higher the number, the greater the amount of air.

For example, when there is a difference between the set value of the amount of air discharged to the front seats at Level 5 and the set value of the amount of air discharged to the rear seats at Level 3, the amount of air discharged to the front seats is greater than the amount of air discharged to the rear seats, and thus in order to match the amount of air discharged to the rear seats, the amount of air flowing into the rear seats through the rear seat distribution unit 200 needs to be adjusted separately.

In this case, when each of the set value of the amount of air discharged to the left side of the rear seat and the set value of the amount of air discharged to the right side of the rear seat is at the same level, that is, Level 3, the amount of air discharged from the left side of the rear seat to the rear seat outlet 201 and the amount of air discharged from the right side of the rear seat to the rear seat outlet 201 are the same, and thus there is no need to adjust the amount of air through the auxiliary air amount adjustment door unit 240.

The rear seat distribution unit 200 may adjust the amount of air so that the set value discharged to the rear seats is at Level 3 by rotating the main door 232 so that a gap d between the inner wall of the rear seat outlet 201 and the main door 232 is reduced, thereby reducing the amount of air flowing into the rear seat outlet 201.

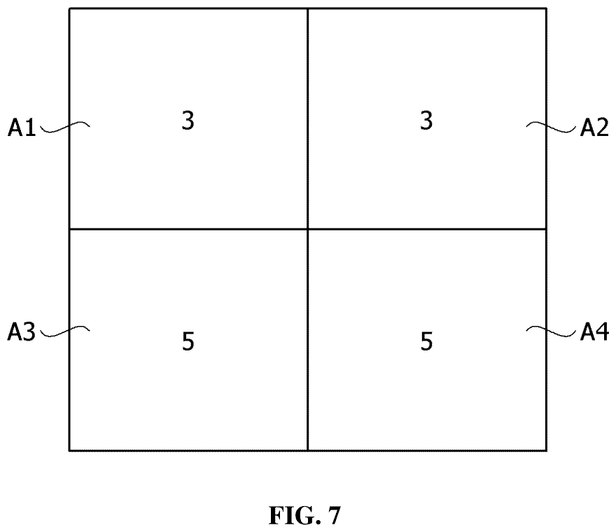

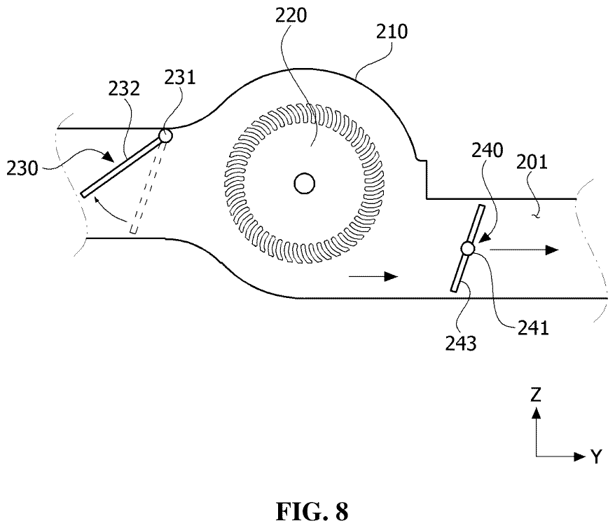

FIG. 7 is a view showing a case in which the amount of air discharged to rear seats is greater than the amount of air discharged to front seats in a state in the amounts of air flowing to the driver's seat and the front passenger's seat are the same in the case of four zones, and FIG. 8 is a view showing movements of the main air amount adjustment door unit 230 and the auxiliary air amount adjustment door unit 240 in the case of four zones of FIG. 7.

Referring to FIGS. 7 and 8, for example, when the set value of the amount of air discharged to the rear seats is greater than the set value of the amount of air discharged to the front seats in a state in which the set value of the amount of air discharged to the front seats is at Level 3 and the set value of the amount of air discharged to the rear seats is at Level 5, the rear seat distribution unit 200 may adjust the amount of air so that the set value discharged to the rear seats is at Level 5 by rotating the main door 232 to increase the gap between the inner wall of the rear seat outlet 201 and the main door 232, thereby increasing the amount of air flowing into the rear seat outlet 201.

In this case, since each of the set value of the amount of air discharged to the left side of the rear seat and the set value of the amount of air discharged to the right side of the rear seat are at the same level, that is, Level 5, there is no need to adjust the amount of air through the auxiliary air amount adjustment door unit 240.

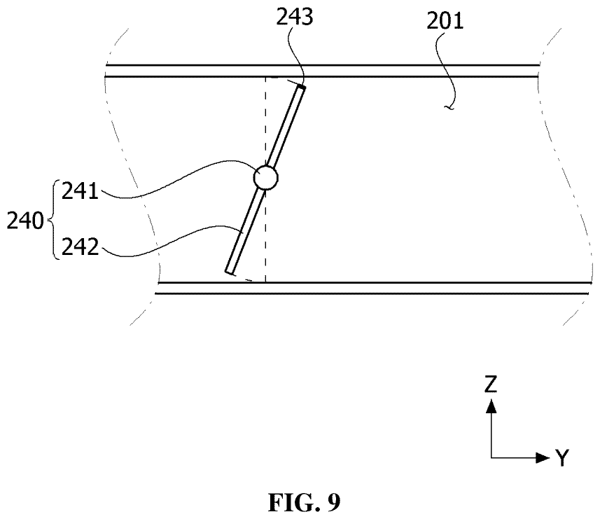

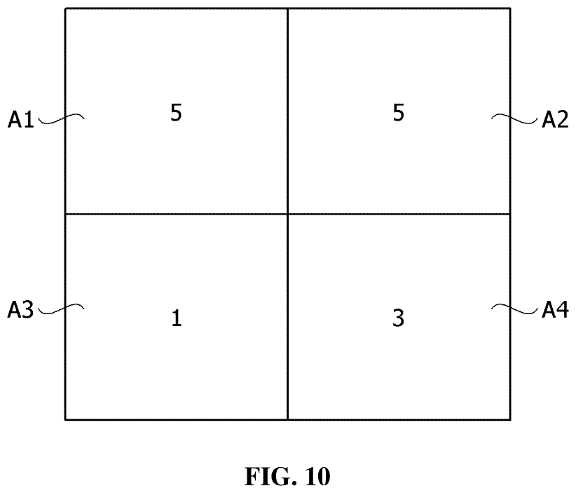

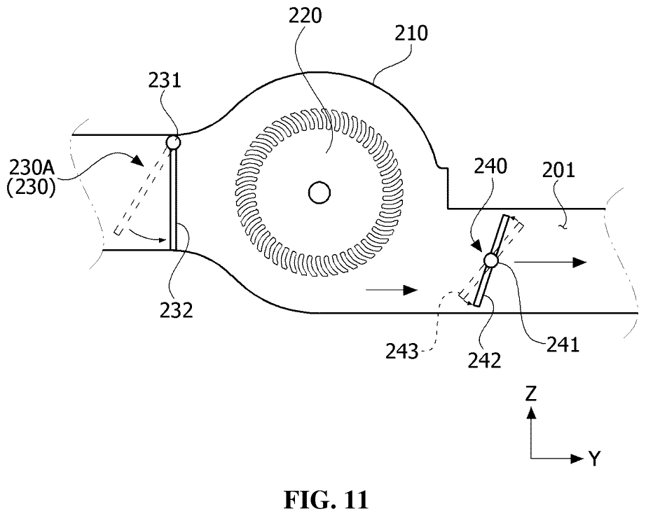

FIG. 9 is a view showing the auxiliary air amount adjustment door unit 240, FIG. 10 is a view showing a case in which the amounts of air flowing to the driver's seat and the front passenger's seat in the rear seats are different in the four zones, and FIG. 11 is a view showing movements of the main air amount adjustment door unit 230 and the auxiliary air amount adjustment door unit 240 in the case of four zones of FIG. 10.

Referring to FIGS. 9 to 11, the second rotational shaft 241 of the auxiliary air amount adjustment door unit 240 is disposed on the central portion of the auxiliary door 242. In addition, the auxiliary air amount adjustment door unit 240 is disposed behind the rear seat blower 220. The auxiliary air amount adjustment door unit 240 can additionally and precisely control the amount of air adjusted through the main air amount adjustment door unit 230.

When there is a difference between the set value of the amount of air discharged to the left side of the rear seat and the set value of the amount of air discharged to the right side of the rear seat In a situation where there is a difference between the set value of the amount of air discharged to the front seats and the set value of the amount of air discharged to the rear seats, since the left blower 221 and the right blower 222 are rotated by one motor 250, it is necessary to independently control the amounts of air of the left and rights through a left auxiliary air amount adjustment door unit 240A and a right auxiliary air amount adjustment door unit 240B.

For example, in a state in which the set value of the amount of air discharged to the front seats is at Level 5, the set value of the amount of air discharged to the left side of the rear seat is at Level 1, and the set value of the amount of air discharged to the right side of the rear seat is at Level 3, since the amount of air discharged to the front seats is greater than the amount of air discharged to the rear seats, the amount of air flowing into the rear seats through the main air amount adjustment door unit 230 is separately adjusted to match the amount of air discharged to the rear seats.

In addition, since the set value of the amount of air discharged to the left side of the rear seat is smaller than the set value of the amount of air discharged to the right side of the rear seat, the rear seat distribution unit 200 may reduce the opening degree of the left auxiliary air amount adjustment door 240A, thereby reducing the amount of air flowing into the rear seat outlet 201 from the rear seat left flow path U3 and thus unlike the rear seat right flow path U4, the rear seat distribution unit 200 may adjust the amount of air so that the set value discharged from the rear seat left flow path U3 is at Level 1.

Although not shown, conversely, when the set value of the amount of air discharged to the left side of the rear seat is at Level 3 and the set value of the amount of air discharged to the right side of the rear seat is at Level 1, the rear seat distribution unit 200 may reduce the opening degree of the right auxiliary door 242, thereby reducing the amount of air flowing into the rear seat outlet 201 in the rear seat right flow path U4, and thus unlike the rear seat left flow path U3, the rear seat distribution unit 200 may adjust the amount of air so that the set value discharged from the rear seat right flow path U4 is at Level 1.

In this way, even when the amounts of air of the left and right side of the rear seat are different, the auxiliary air amount adjustment door unit 240 can increase the controllability of the amount of air discharged to the rear seats.

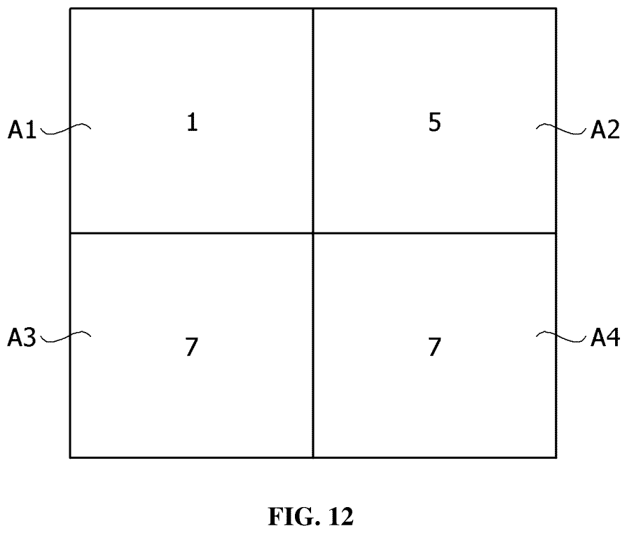

FIG. 12 is a view showing a state in which the amounts of air of a left side of a front seat and a right side of the front seat are independently controlled in the four zones.

Referring to FIG. 12, in a state in which there is a difference between a first set value of the amount of air discharged to the left side of the front seat and a second set value of the amount of air discharged to the right side of the front seat, when a third set value of the amount of air discharged to the left side of the rear seat and a fourth set value of the amount of air discharged to the right side of the rear seat are the same, the air required for the rear seats cannot be sufficiently supplied from the front seats.

For example, in a state in which the first set value is at Level 1 and the second set value is at Level 5, which are different, and the amounts of air of the first zone and the second zone are independently adjusted, when the third set value is at Level 7 and the fourth set value is at Level 7, which are the same, the air of the first zone cannot be sufficiently supplied to the third zone because the first set value at Level 1 is smaller than the third set value at Level 7.

In this case, a controller may increase the speed of the rear seat blower 220 to increase the overall amount of air supplied to the rear seats. In addition, by reducing the opening degree of the auxiliary air amount adjustment door unit 240 corresponding to the fourth zone A4, it is possible to reduce a deviation between the amount of air discharged from the third zone A3 and the amount of air discharged from the fourth zone A4.

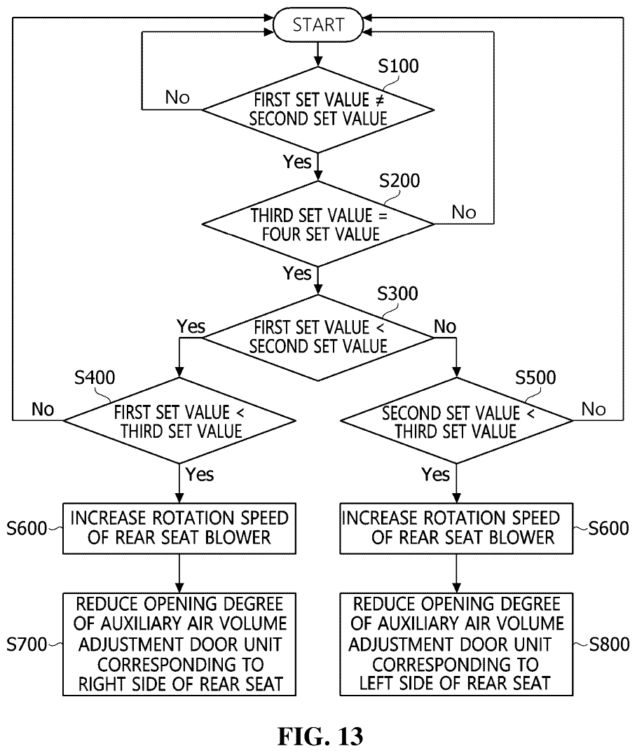

FIG. 13 is a view showing a control method of an air conditioner for a vehicle according to an embodiment.

Referring to FIGS. 12 and 13, a control method of an air conditioner for a vehicle according to an embodiment for reducing the deviation between the amount of air discharged from the third zone A3 and the amount of air discharged from the fourth zone A4 first determines whether there is a difference between the first set value and the second set value (S100). That is, the rear seat distribution unit 200 checks whether the amounts of air of the left side of the front seat and the right side of the front seat are independently controlled.

Next, when there is a difference between the first set value and the second set value, the controller determines whether the third set value and the fourth set value are the same (S200). That is, as the amount of air required on the left side of the rear seat and the amount of air required on the right side of the rear seat are the same and the amounts of air flowing to the left side of the front seat and the right side of the front seat are independently controlled, the controller checks whether it is a state in which a deviation between the amount of air at the left side of the rear seat and the amount of air at the right side of the rear seat may occur. For example, the first set value is at Level 1 and the second set value is at Level 5, and in a state in which the first set value is smaller than the second set value, the third set value and the fourth set value may be at the same level, that is, Level 7.

Next, when the third set value and the fourth set value are the same, the controller determines whether the first set value is smaller than the second set value (S300).

Next, when the first set value is smaller than the second set value, the controller determines whether the first set value is smaller than the third set value (S300). This is to determine whether the amount of air required in the rear seats is insufficient due to the low air amount at the left side of the front seat. For example, when the first set value is at Level 1 and the second set value is at Level 5, the first set value is smaller than the second set value, and when the third set value is at Level 7, the first set value is smaller than a seventh set value.

Next, when the first set value is smaller than the third set value, the controller may increase a rotation speed of the rear seat blower 220 (S600). As the rotation speed of the rear seat blower 220 increases, the overall amount of air supplied to the rear seats may be increased. For example, when the first set value is at Level 1 and the third set value is at Level 7, the air supplied from the first zone A1 to the third zone A3 may be insufficient, and by increasing the rotation speed of the rear seat blower 220, the overall air supplied to the third zone A3 and the fourth zone A4 may be increased.

Next, the controller reduces the opening degree of the right auxiliary air amount adjustment door unit 240B corresponding to the right side of the rear seat (S700). As the rotation speed of the rear seat blower 220 increases, the overall amount of air supplied to the rear seats increases, and thus by reducing the opening degree of the right auxiliary air amount adjustment door unit 240B, it is possible to reduce the amount of air at the left side of the rear seat and the amount of air at the right side of the rear seat.

Next, when the second set value is smaller than the first set value, the controller determines whether the second set value is smaller than the third set value (S500). This is to determine whether the amount of air required in the rear seats is insufficient due to the low air amount at the right side of the front seat.

Next, when the second set value is smaller than the third set value, the controller may increase the rotation speed of the rear seat blower 220 (S600). As the rotation speed of the rear seat blower 220 increases, the overall amount of air supplied to the rear seats may be increased.

Next, the controller reduces the opening degree of the left auxiliary air amount adjustment door unit 240A corresponding to the left side of the rear seat (S800). As the rotation speed of the rear seat blower 220 increases, the overall amount of air supplied to the rear seats increases, and thus by reducing the opening degree of the left auxiliary air amount adjustment door unit 240A, it is possible to reduce the amount of air at the left side of the rear seat and the amount of air at the right side of the rear seat.

The air conditioner for a vehicle according to one exemplary embodiment of the present disclosure has been described above in detail with reference to the accompanying drawings. The above embodiments of the present invention should be understood in all respects as illustrative and not restrictive, and the scope of the present invention will be determined by the claims to be described below rather than the above-described detailed description. In addition, not only the meanings and scopes of the claims but also all changeable or modifiable forms derived from the equivalent concept thereof should be construed as being included in the scope of the present invention.

1. An air conditioner for a vehicle, comprising:
an air conditioning unit configured to adjust a temperature of air; and
a rear seat distribution unit configured to communicate with the air conditioning unit and guide air of the air conditioning unit to rear seats,
wherein the rear seat distribution unit includes a housing that communicates with the air conditioning unit and includes a rear seat outlet, a rear seat blower disposed inside the housing, a main air amount adjustment door unit disposed in front of the rear seat blower, and an auxiliary air amount adjustment door unit disposed behind the blower,
when there is a difference between a set value of an amount of air discharged to front seats and a set value of an amount of air discharged to the rear seats, the rear seat distribution unit adjusts an opening degree of the main air amount adjustment door unit to adjust an amount of air discharged through the rear seat outlet, and
when there is a difference between a set value of an amount of air discharged to a left rear seat and a set value of an amount of air discharged to a right rear seat, an opening degree of the auxiliary air amount adjustment door unit is adjusted to adjust the amount of air discharged through the rear seat outlet.

2. The air conditioner of claim 1, wherein a rotational shaft of the main air amount adjustment door unit and a rotational shaft of the auxiliary air amount adjustment door unit are different with respect to a height direction of the rear seat outlet.

3. The air conditioner of claim 2, wherein the rotational shaft of the main air amount adjustment door unit is located on an inner wall of the rear seat outlet.

4. The air conditioner of claim 2, wherein a first rotational shaft of the main air amount adjustment door unit is disposed to be spaced apart from an inner wall of the rear seat outlet.

5. The air conditioner of claim 1, wherein a first rotational shaft of the main air amount adjustment door unit is disposed on an end of a main door, and a rotational shaft of the auxiliary air amount adjustment door unit is disposed on a central portion of an auxiliary door.

6. The air conditioner of claim 5, wherein the auxiliary air amount adjustment door unit includes a sealer disposed on an end of the auxiliary air amount adjustment door unit, and the sealer comes into contact with an inner wall of the rear seat outlet earlier than the auxiliary air amount adjustment door unit.

7. (canceled)

8. The air conditioner of claim 1, wherein the air conditioning unit is formed to be divided into a front seat left flow path and a rear seat right flow path by a partition wall, and the distribution unit is formed to be divided into a rear seat left flow path and a rear seat right flow path by a partition wall, and
the rear seat outlet communicates with the front seat left flow path and the rear seat left flow path, and the rear seat right flow path and the rear seat right flow path communicate with each other.

9. The air conditioner of claim 8, wherein the rear seat blower includes a left blower disposed on the rear seat left flow path and a right blower disposed on the rear seat right flow path, and
the left blower and the right blower are connected to one motor.

10. The air conditioner of claim 8, wherein the auxiliary air amount adjustment door unit includes a left auxiliary air amount adjustment door unit disposed on the rear seat left flow path and a right auxiliary air amount adjustment door unit disposed on the rear seat right flow path.

11. The air conditioner of claim 10, wherein, when a set value of an amount of air discharged to the rear seat right flow path is greater than a set value of an amount of air discharged to the rear seat left flow path, an opening degree of the left auxiliary air amount adjustment door unit is adjusted to be smaller than an opening degree of the right auxiliary air amount adjustment door unit.

12. The air conditioner of claim 11, wherein, when the set value of the amount of air discharged to the rear seat right flow path is smaller than the set value of the amount of air discharged to the rear seat left flow path, the opening degree of the left auxiliary air amount adjustment door unit is adjusted to be greater than the opening degree of the right auxiliary air amount adjustment door unit.

13. The air conditioner of claim 1, wherein the rear seat distribution unit further includes a mode door unit that is disposed behind the auxiliary air amount adjustment door unit and adjusts air discharged through a rear seat floor vent or a rear seat console vent.

14. An air conditioner for a vehicle, comprising:
an air conditioning unit configured to adjust a temperature of air, the air conditioning unit including a main blower, a cooling heat exchanger, a heating heat exchanger, and a front seat distribution unit configured to guide air of the air conditioning unit to front seats; and
a rear seat distribution unit that communicates with the air conditioning unit and guides air of the air conditioning unit to rear seats,
the front seat distribution unit includes a front seat left and right air amount adjustment door for front seat left and right independent air amounts,
the rear seat distribution unit includes a housing that communicates with the air conditioning unit and includes a rear seat outlet, a rear seat blower disposed inside the housing, and a rear seat air amount adjustment door for rear seat left and right independent air amounts, and
a controller configured to control the rear seat air amount adjustment door according to a difference between amounts of air of a left and a right of a front seat.

15. The air conditioner of claim 14, wherein the rear seat air amount adjustment door includes a main air amount adjustment door unit disposed in front of the rear seat blower, and an auxiliary air amount adjustment door unit disposed behind the rear seat blower, and
in a state in which there is a difference between a first set value of an amount of air discharged to a left side of the front seat and a second set value of an amount of air discharged to a right side of the front seat, when a third set value of an amount of air discharged to a left side of the rear seat and a fourth set value of an amount of air discharged to a right side of the rear seat are the same,
the rear seat distribution unit reduces an opening degree of the auxiliary air amount adjustment door unit corresponding to the right side of the rear seat when the first set value is smaller than the second set value, and
reduces an opening degree of the auxiliary air amount adjustment door unit corresponding to the left side of the rear seat when the second set value is smaller than the first set value.

16. The air conditioner of claim 15, wherein, in a state in which the first set value and the second set value are different, when the third set value and the fourth set value are the same, the rear seat distribution unit increases a speed of the rear seat blower.

17. The air conditioner of claim 16, wherein the opening degree of the auxiliary air amount adjustment door unit is adjusted so that the amount of air discharged to the left side of the rear seat and the amount of air discharged to the right side of the rear seat are the same.

18. The air conditioner of claim 17, wherein the rear seat distribution unit changes the speed of the rear seat blower in response to a speed of the front seat blower.

19. The air conditioner of claim 14, wherein the air conditioning unit is formed to be divided into a front seat left flow path and a rear seat right flow path by a partition wall, and the rear seat distribution unit is formed to be divided into a rear seat left flow path and a rear seat right flow path by a partition wall, and
the rear seat outlet communicates with the front seat left flow path and the rear seat left flow path, and the rear seat right flow path and the rear seat right flow path communicate with each other.

20-21. (canceled)

22. A control method of the air conditioner for a vehicle of claim 15, the control method comprising:
an operation (a) of determining whether the first set value and the second set value are different;
an operation (b) of determining whether the third set value and the fourth set value are the same when the first set value and the second set value are different;
an operation (c) of increasing a rotation speed of the rear seat blower when the third set value and the fourth set value are the same;
an operation (d) of reducing the opening degree of the auxiliary air amount adjustment door unit corresponding to the right side of the rear seat when the first set value is smaller than the second set value; and
an operation (e) of reducing the opening degree of the auxiliary air amount adjustment door unit corresponding to the left side of the rear seat when the second set value is smaller than the first set value.

23. The control method of claim 22, wherein the opening degree of the auxiliary air amount adjustment door unit is adjusted so that the amount of air discharged to the left side of the rear seat and the amount of air discharged to the right side of the rear seat are the same.
